(19) United States
(12) Patent Application Publication
(10) Pub. No.: US 2007/0098189 A1
(43) Pub. Date: May 3, 2007

(54) Speaker drive system for headsets and method

(76) Inventor: Vladimir Walter Kukurudza, Markham (CA)

Correspondence Address: GEORGE A. ROLSTON, 45 SHEPPARD AVE EAST, SUITE 900, TORONTO, ON, M2N5W9, CA

(21) Appl. No.: 11/260,458

(22) Filed: Oct. 28, 2005

(51) Int. Cl. H04R 3/00; H04R 9/06

(52) U.S. Cl. 381/117; 381/401; 381/111

(57) ABSTRACT

A speaker driver circuit for use in association with a source of audio signals and a single coil driven speaker, for communicating said signals to the speaker and for reducing unwanted noise in the speaker, and having a first coil connected between the output of the audio signal source and the input of the speaker, a second coil, connected between the speaker and the ground of the audio signal source, the second coil being bifilar wound with the first coil, so that signals passing through the first coil, and through the speaker and then through the second coil will substantially reduce unwanted noise in the speaker, and first and second capacitors connected between the first coil, and the second coil.

### FIELD OF THE INVENTION

The invention relates to a drive circuit for driving a speaker coil such as the speaker coil of headset speaker systems and to an audio reproduction system incorporating such a drive circuit. The invention will be applicable to a variety of small scale speaker systems, including electronic hearing aids.

### BACKGROUND OF THE INVENTION

Headset speaker systems using coil driven speakers and other small scale speaker systems usually involve relatively primitive drive circuits connected between the signal source and the speaker. Generally speaking such smaller scale speakers systems are built down to a price. Clarity and performance may be sacrificed. Such speaker systems may involve simple, portable players such as CD and MP3 and telephone systems, two-way hand held radio communication systems, hand held loud speakers such as are used in crowd control, portable radios, aircraft communication, intercom systems, auto radio, and military mobile radio systems, police radio, and household and apartment communication systems, and in public address systems and electronic hearing aids.

In such headset and other speaker systems, the sound signal frequencies from the amplifier are passed through simple circuits, to feed signals over the full frequency range to each speaker. This is to be distinguished from the type of situation in more complex audio systems where there are three speakers for high, medium and low frequencies. In these systems, complex crossover circuits are used to separate the high, medium and low frequency signals, and direct them to their respective speakers, so that the high, medium, and low range sounds are reproduced separately in the separate speakers.

In a typical small scale speaker system all of the sounds high, medium and low, are reproduced in the small speakers.

As is well known, the resulting sound as heard by a listener is very far from satisfactory, and is frequently subject to distortion.

It is believed that a significant factor leading to such distortion is the distortion of the signals as they pass through the speaker coil, due to back EMF noise signals induced in the speaker coil as the signals pass through it. In some driver systems there may be one or more coils connected to the speaker coil itself. As the audio signal currents pass through these coils, they will inevitably create noise such as further “back EMF”, or other noise in the circuit.

In U.S. Pat. No. 5,373,563, Inventor, Vladimir W. Kukurudza, Title: SELF DAMPING SPEAKER MATCHING DEVICE, dated Dec. 13, 1994, there is disclosed a crossover system for dividing an audio signal into high, medium, and low frequencies, and directing them to the appropriate speakers, and at the same time, reducing the distortion caused in those speakers by the passage of the audio signal currents through them.

That system has proved to be highly effective with multiple speaker systems having either high or low, or high, medium, and low speakers. However, the system is not suitable for use with small scale single speakers, or small speaker pairs such as a headset where crossover circuits are not used.

### BRIEF SUMMARY OF THE INVENTION

With a view to achieving the improvements described above in small scale speaker systems, the invention comprises an audio signal reproduction system having, a source of audio signals, at least one single coil driven speaker, a speaker drive circuit for communicating the signals to the speaker and for reducing unwanted noise in the speaker, the system having a first coil with a first coil input connected to the feed of said audio circuit and with a first coil output connected to the single speaker, and further having a second coil with a second coil input connected to the speaker output and having a second coil output connected to the ground of the audio signal system, said first coil and second coil being bifilar wound together whereby signals in a first frequency range passing through said first coil, and through said speaker coil and then through said second coil will substantially reduce unwanted noise in said speaker, a first capacitor connected between said coil input of said first coil and the coil input to the second coil, and, a second capacitor connected between the coil output of the first coil and the coil output of the second coil, whereby signals in a second frequency range will pass through said first capacitor, then through said speaker coil and then through said second capacitor and back to said ground of said audio circuit.

In the illustrated form of the invention, each of the first and second coils is considered to have an input end and an output end, the signals being carried from the input end through each of the coils in sequence to the output end, for the purposes of explanation. In the bifilar winding of the coils, the input ends of each coil are placed together and the output ends of each of the coils are placed together, so that the currents flow through the coils from their respective inputs to their respective output ends in the same direction.

The invention is equally applicable to a system having only one speaker or to a system have two or more speakers.

The invention also provides a method of processing signals as described above. The various features of novelty which characterize the invention are pointed out with more particularity in the claims annexed to and forming a part of this disclosure. For a better understanding of the invention, its operating advantages and specific objects attained by its use, reference should be had to the accompanying drawings and descriptive matter in which there are illustrated and described preferred embodiments of the invention.

### IN THE DRAWINGS

FIG. 1 is a schematic circuit diagram showing an audio reproduction system, and the driver circuit associated therewith illustrating the invention;

FIG. 2 is a schematic circuit diagram showing the bifilar wound coils, illustrated in FIG. 1;

FIG. 3 is a cut away side elevation corresponding to FIG. 2 illustrating the bifilar winding of the coils;

FIG. 4 is a sketch of a typical headset system using the circuits according to the invention; and

FIG. 5 illustrates the typical plot of a comparison of the response of a speaker to low and high frequency signals, without the invention, and to a speaker equipped with the invention.

### DESCRIPTION OF A SPECIFIC EMBODIMENT

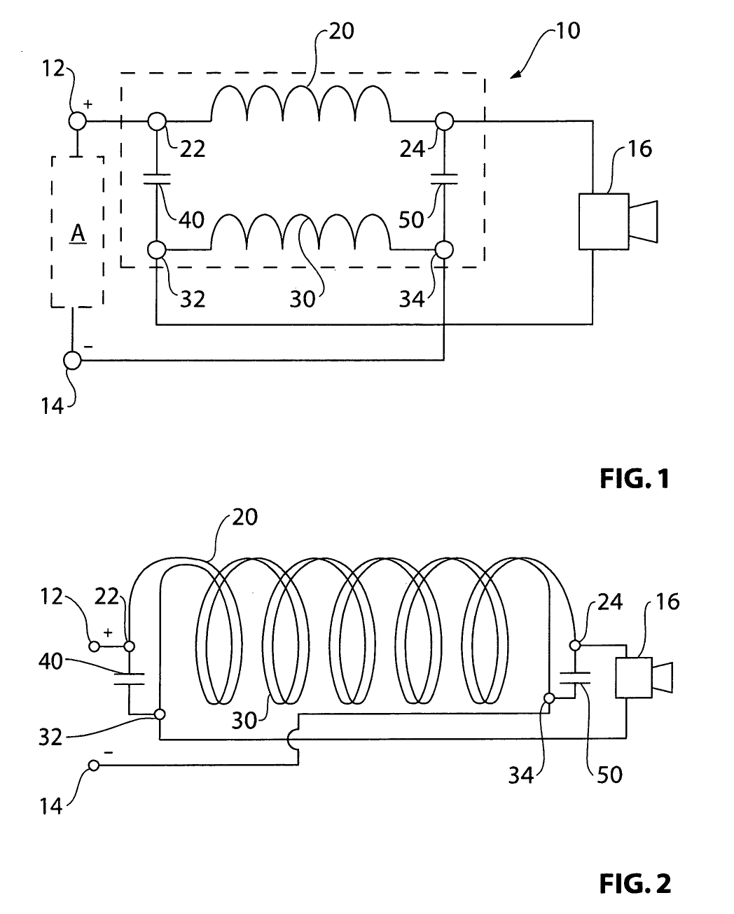

Referring first of all, to FIG. 1, it will be seen that the invention is there illustrated in the form of an audio sound reproduction system having a source of audio signals A, connected to a speaker driver circuit indicated generally as (10). Circuit (10) is shown a being connected to an audio signal feed (12) and ground (14) of source A. This will be understood to represent any form of audio signal generator or source, or amplifier. Such systems are of many types. One popular system is the MP3 system. CD systems and even tape systems are known. Small R/F transmitter/receiver systems, and even wireless telephones or hearing aids, may all incorporate driver circuits of this invention.

The driver circuit (10) is shown connected to a single coil-driver speaker (16). While only one such driver circuit (10) and speaker (16) is shown it will be appreciated that two or more such driver circuits and speakers may be incorporated in a single system, one for each speaker, in some cases.

Accordingly, for the purposes of this description, the use of the singular term is to be understood as including the plural. For example, in a typical headset there are two speakers, one for each ear. The driver circuit(s) would normally be built into the source of audio signals. Alternatively, the driver circuit (10) may be provided in an intermediate plug-in coupling unit (see FIG. 4), which couples the source A to both of the speakers.

For the purposes of this explanation, it will be considered that the audio signals travel from the audio feed (12) through the driver circuit (10) to the exit from the speaker and return through the driver circuit to the audio circuit at the ground (14). In accordance with well established scientific convention, the audio currents are considered for the purposes of explanation as passing in the manner described above, i.e. from + to −.

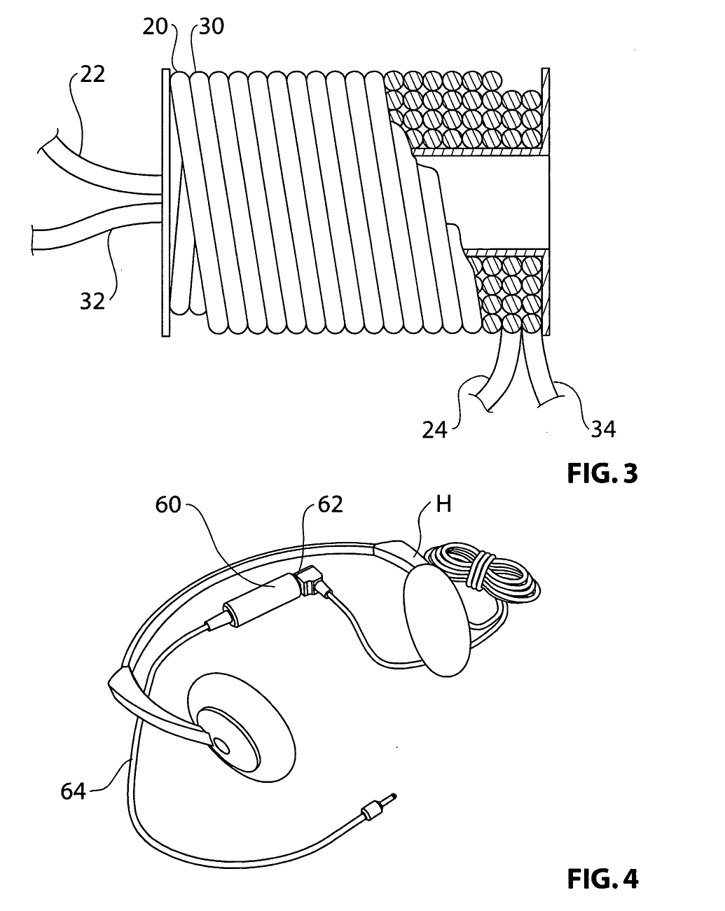

As further illustrated in FIG. 1, the driver circuit (10) is represented as having a pair of coils (20) and (30). These coils (20) and (30) are illustrated as two separate coils within respective one phantom box. In fact the two coils are wound in a bifilar manner as illustrated in FIGS. 2 and 3.

The first coil (20) has a first coil input end (22) and a first coil output end (24). The second coil (30) has a second coil input end (32) and a second coil output end (34).

The coils (20) and (30) are wound in a bifilar manner as generally illustrated in FIG. 2 and 3, with their coil inputs (22) and (32) adjacent one another and their coil outputs (24) and (34) adjacent one another. The bifilar winding of the two coils is a technique whereby the wire windings of the first coil (20) and the second coil (30) are wound in the same direction simultaneously onto a core. Each winding of the wire of one coil (20) is side-by-side with the adjacent winding of the other coil (30). This continues down the length of each layer of windings in the coils. This is illustrated in FIGS. 2 and 3, but the explanation is worth putting in writing since it may not be appreciated how the coil is actually made. Signal currents passing through the two coils pass in the same direction through both coils. However, as will become apparent from the following description, the signals in coil (30) are slightly delayed compared with the signals in coil (20) resulting from passage of the signals through coil (20) and through the coil of the speaker (16).

This effectively produces a suppression of noise signals that would otherwise be generated thus significantly improving the clarity of reproduction.

The physical explanation as to why the passing of the signal through the first and second bifilar wound coils (20) and (30) produces a suppression of noise is believed to be that there are magnetic fields produced by signals passing through the two coils, which are so close in time, and are the of the same polarity, so that the fields oppose one another, and cancel out thereby preventing a field buildup which would normally develop in a single wire coil, therefore there is no collapsing field to create distortion. Although there are similar opposed fields, which cancel each other out, there is still a magnetic force extending between the coils. This prevents any erratic movements of the speaker coil and thus prevents distortion.

It must be understood, however, this is merely one suggested explanation of the manner in which the bifilar wound coils suppress noise. It may be that upon further experimentation and examination, the exact explanation is somewhat different.

In order to improve the sound quality a high frequency response capacitor (40) is connected between the input ends of the first and second coils (20) and (30), and a second high frequency capacitor (50) is connected between the output ends of the first and second coils (20) and (30). Due to the relation between coils and capacitors, higher frequencies passing through the capacitor reach the voice coil, at a different time than the lower frequencies passing through the coils. The time differences are minute in comparison thus resulting in a broad flat response in a single loudspeaker.

The explanation for this is as follows. The lower frequency range of signals will pass through the first coil (20) then through the speaker and then through the second coil (30) and back to ground.

However, the higher frequency signals will pass through the first capacitor (40) then through the speaker (16) and then through capacitor (50) and back to ground. Only the high frequencies will thus pass through the first capacitor (40) and second capacitor (50) and only the low frequencies will pass through the coils (20) and (30).

Due to the slight delay between the high frequency and low frequency signals, the signals arrive at the speaker coil at different times. The time difference is minute, possibly in the order of nanoseconds or milleseconds. The result is the production of clearer sound from even a relatively small, inexpensive speaker.

It is found that in practice this leads to an improvement in sound reproduction and noise reduction.

As shown in FIG. 4 the speaker driver circuit can be built in a small package or container indicated as (60), which can be simply plugged into a typical headset H.

Container (60) has a female recess receptacle (62) at one end, and a connecting wire and male plug (64) at the other. The container (60) can thus be supplied as a unique enhancement to existing headsets, without the need for replacing the headset.

The circuit can also be incorporated in a new headset, or other sound reproducer such as a wireless phone, two-way radio, or even a hearing aid.

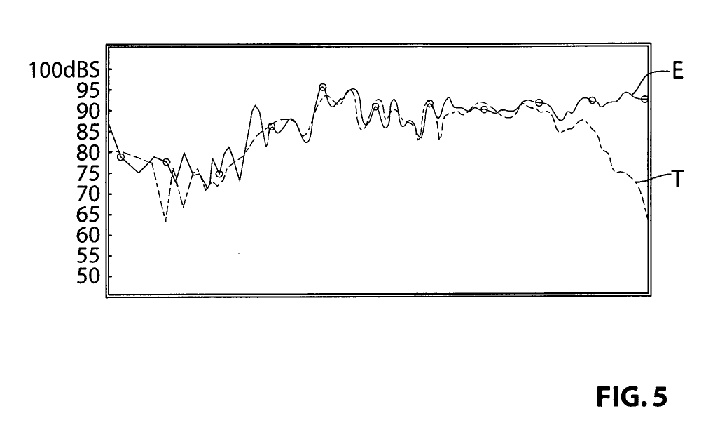

The improved response achieved by the speaker driver circuit is illustrated in FIG. 5. Plot T indicates the typical signal response of a standard sound system and headset, with significant deterioration at the low and high ends of the frequency spectrum.

Plot E indicates the enhanced signal response of a sound system equipped with the speaker drive circuit, showing a much more uniform, flatter response over a wide range from low to high.

The method according to the invention will thus be seen to consist of passing low frequency audio signals through the first coil (20) and then through said speaker coil (16) and then through said second coil (30). The signals pass through the coils (20) and (30) in the same direction creating fields around the two coils which are of the same orientation and polarity and therefore oppose one another. This prevents any field from developing and thus reduces or prevents distortion. As explained above, although there are similar opposed fields, which cancel each other out, there is still a magnetic force extending between the coils. This prevents any erratic movements of the speaker coil and thus prevents distortion.

The method further includes the steps of passing high frequency audio signals through a first capacitor (40) connected between the input end of the first coil (20) and the input end of the second coil (30)and then through the speaker coil. When they exit from said speaker coil, they pass through second capacitor (50), connected between the output ends of coils (20) and (30) and so to ground.

The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A speaker driver circuit for use in association with a source of audio signals and a coil driven speaker, for communicating said signals to said speaker and for reducing unwanted noise in said speaker, said speaker driver circuit comprising:
a first coil connected between the output of said audio signal source and the input of said speaker,
a second coil, connected between said speaker and the ground of the audio signal source, said second coil being bifilar wound with said first coil, whereby signals passing through said first coil, and through said speaker and then through said second coil will substantially reduce unwanted noise in said speaker, and first and second capacitors connected between said first coil, and said second coil.

2. A speaker driver system as claimed in claim 1 and wherein said first coil has a first coil input end and first coil output end and said second coil has a second coil input end and a second coil output end, the signals being carried from the said input ends through the said coils to said output ends, in the same direction in both coils, in sequence.

3. A speaker driver system as claimed in claim 2 and wherein the input ends of each coil are placed together and the output ends of each of the coils are placed together, so that the signal currents flow through the coils from their respective input ends to their respective output ends in the same direction.

4. A speaker driver system as claimed in claim 1 wherein said coils pass low frequency signals and said capacitors pass high frequency signals.

5. A speaker driver system as claimed in claim 4, including a first capacitor connected between said first coil input end and said second coil input end, and a second capacitor connected between said first coil output end and said second coil output end whereby low frequency signals pass through said first coil, said speaker, and said second coil in a sequence, and high frequency signals pass through said first capacitor, said speaker and said second capacitor.

6. A speaker driver system as claimed in claim 1, wherein any one winding of said first coil is spaced apart from the next winding of said first coil and wherein each winding of said second coil lies adjacent to a winding of said first coil.

7. A method of operating a system of audio signal reproduction, for delivering audio signals from said reproduction system to at least one speaker, including the steps of;
passing low frequency audio signals through a first coil and then through said respective speaker, and then through a second coil, and then returning to said audio system; wherein said first and second coils are bifilar wound and wherein said signals pass through said first and said second coils in the same direction and,
passing high frequency audio signals through a first capacitor, then through said speaker, then through a second capacitor, and then returning to said audio system.

8. A method of operating a system of audio signal reproduction, as claimed in claim 7, and wherein said first and second coils have respective coil input ends adjacent to one another and respective coil output ends adjacent to one another and including subjecting said signals to the action of a first capacitor connected between adjacent input ends of said first and second coils, and subjecting said signals to the action of a second capacitor connected between the output ends of said first coil and said second coil, whereby to takes advantage of the phase and time relation between coils and capacitors resulting in a broader and flat response in a single loudspeaker system.
